(19) United States
(12) Patent Application Publication
(10) Pub. No.: US 2025/0165909 A1
(43) Pub. Date: May 22, 2025

(54) VEHICLE OPERATION MANAGEMENT SYSTEM, VEHICLE OPERATION MANAGEMENT METHOD, AND COMPUTER PROGRAM

(71) Applicant: SUMITOMO ELECTRIC INDUSTRIES, LTD., Osaka-shi, Osaka (JP)

(72) Inventor: Yu URATA, Osaka-shi (JP)

(73) Assignee: SUMITOMO ELECTRIC INDUSTRIES, LTD., Osaka-shi, Osaka (JP)

(21) Appl. No.: 18/873,534

(22) PCT Filed: Mar. 30, 2023
(86) PCT No.: PCT/JP2023/013089

§ 371 Date: Dec. 10, 2024

(30) Foreign Application Priority Data
Jun. 17, 2022 (JP) 2022-097768

(51) Int. Cl. G06Q 10/0833; G07C 5/08

(52) U.S. Cl. CPC G06Q 10/0833; G07C 5/0841

(57) ABSTRACT

A vehicle operation management system includes: a travel record information acquisition unit that acquires travel record information indicating a position of a vehicle, a time at which the vehicle has passed through the position, and a speed of the vehicle at the time; a destination information acquisition unit that acquires destination information indicating a position of a destination of the vehicle; and a determination unit that determines an arrival time of the vehicle at the destination and a departure time of the vehicle from the destination, based on the travel record information and the destination information.

### TECHNICAL FIELD

The present disclosure relates to a vehicle operation management system, a vehicle operation management method, and a computer program.

This application claims priority on Japanese Patent Application No. 2022-097768 filed on Jun. 17, 2022, the entire content of which is incorporated herein by reference.

### BACKGROUND ART

PATENT LITERATURE 1 discloses a cargo handling situation management system that identifies the start time and the end time of cargo handling in a work facility, based on information on the position of a vehicle and information on whether a door provided at a platform of the vehicle is open or closed.

PATENT LITERATURE 2 discloses a judgement device that judges that a vehicle has changed from a moving state to a stopped state in a case where the speed of the vehicle is equal to or less than a threshold.

### CITATION LIST

### Patent Literature

PATENT LITERATURE 1: Japanese Laid-Open Patent Publication No. 2018-162149
PATENT LITERATURE 2: Japanese Laid-Open Patent Publication No. 2017-91163

### SUMMARY OF THE INVENTION

### Solution to Problem

A vehicle operation management system according to an embodiment of the present disclosure includes: a travel record information acquisition unit that acquires travel record information indicating the position of a vehicle, a time at which the vehicle has passed through the position, and the speed of the vehicle at the time; a destination information acquisition unit that acquires destination information indicating the position of a destination of the vehicle; and a determination unit that determines an arrival time of the vehicle at the destination and a departure time of the vehicle from the destination, based on the travel record information and the destination information.

### BRIEF DESCRIPTION OF DRAWINGS

FIG. 1 is a diagram showing an overall configuration of a vehicle operation management system according to an embodiment of the present disclosure.

FIG. 2 is a block diagram showing a configuration of an in-vehicle terminal.

FIG. 3 shows an example of travel record information generated by a travel record information generation unit.

FIG. 4 is a block diagram showing a configuration of an operation time analysis device.

FIG. 5 shows an example of delivery destination information.

FIG. 6 shows an example of operation time information.

FIG. 7 is a flowchart showing a processing procedure of the operation time analysis device.

FIG. 8 is a flowchart showing a processing procedure of the operation time analysis device.

FIG. 9 shows a map of the area around a delivery destination.

### DETAILED DESCRIPTION

### Problems to be Solved by the Present Disclosure

According to PATENT LITERATURE 1, the start time and the end time of cargo handling can be identified, but an arrival time of the vehicle at the work facility and a departure time of the vehicle from the work facility cannot be accurately identified.

According to PATENT LITERATURE 2, it is possible to identify that the vehicle is stopped, but it is impossible to accurately identify where the vehicle is stopped.

The present disclosure has been made in view of such circumstances, and an object of the present disclosure is to provide a vehicle operation management system, a vehicle operation management method, and a computer program that can accurately identify an arrival time of a vehicle at a destination and a departure time of the vehicle from the destination.

### Effect of the Present Disclosure

According to the present disclosure, the arrival time of the vehicle at the destination and the departure time of the vehicle from the destination can be accurately identified.

### Outline of Embodiment of the Present Disclosure

First, an outline of an embodiment of the present disclosure will be listed and described.
(1) A vehicle operation management system according to an embodiment of the present disclosure includes: a travel record information acquisition unit configured to acquire travel record information indicating a position of a vehicle, a time at which the vehicle has passed through the position, and a speed of the vehicle at the time; a destination information acquisition unit configured to acquire destination information indicating a position of a destination of the vehicle; and a determination unit configured to determine an arrival time of the vehicle at the destination and a departure time of the vehicle from the destination, based on the travel record information and the destination information.

With this configuration, based on a positional relationship between the vehicle and the destination, it can be judged that the vehicle is present at the destination and that the vehicle has departed from the destination. In addition, if the speed of the vehicle is further considered, it can be judged whether or not the vehicle has arrived at the destination. Thus, based on a passing time of the vehicle at the position, the arrival time of the vehicle at the destination and the departure time of the vehicle from the destination can be accurately identified.
(2) In the above (1), the determination unit may determine the arrival time of the vehicle at the destination, based on a result of a judgement on a stay condition indicating that a distance between the vehicle and the destination is equal to or less than a distance threshold and that the speed of the vehicle is equal to or less than a speed threshold.

The vehicle is stopped after having arrived at the destination, and thus satisfies the stay condition after having arrived at the destination. Thus, the arrival time of the vehicle at the destination can be accurately determined by using the result of the judgement on the stay condition.
(3) In the above (2), the determination unit may determine that a time at which the stay condition has started being satisfied is the arrival time of the vehicle at the destination, in a case where the stay condition has been continuously satisfied for a time threshold or more.

If the stay condition has been continuously satisfied for the time threshold or more, it indicates that the vehicle neither is temporarily stopped at the destination nor has passed through the destination, but that the vehicle has surely arrived at the destination. Thus, a time at which the stay condition has started being satisfied is set as the arrival time at the destination, whereby the arrival time of the vehicle at the destination can be accurately determined.
(4) In any one of the above (1) to (3), the travel record information may include sensor information indicating at least one of a state of a handbrake of the vehicle, an open or closed state of a door of the vehicle, an acceleration of the vehicle, engine revolutions per minute of the vehicle, an operation state of an engine of the vehicle, and information acquired by the vehicle from a beacon installed at the destination.

For example, after the vehicle has been stopped, a driver applies the handbrake, and opens or closes the door of the vehicle to get in and out of the vehicle. In addition, the vehicle is found to be stopped, based on the acceleration of the vehicle, the engine revolutions per minute, or the operation state of the engine. Further, the vehicle is found to have arrived at the destination, based on information acquired from a beacon installed at the destination. Thus, the arrival time of the vehicle at the destination can be accurately determined by using the sensor information.
(5) In the above (2) or (3), the determination unit may determine, as the departure time of the vehicle from the destination, a time at which a distance between the vehicle and the destination has exceeded the distance threshold after the vehicle has arrived at the destination.

The departure time of the vehicle from the destination can be accurately determined by using the positional relationship between the vehicle and the destination after the vehicle has arrived at the destination.
(6) In the above (3), the determination unit may reset a continuous duration period of the stay condition to 0, in a case where the number of failures in positioning of the vehicle acquired by the travel record information acquisition unit has exceeded a predetermined number.

In this case, the reliability of the travel record information can be judged to be low. Thus, the continuous duration period of the stay condition is reset to 0, whereby the arrival time at the destination can be determined by using the travel record information with high reliability.
(7) A vehicle operation management method according to another embodiment of the present disclosure includes: causing a computer to acquire travel record information indicating a position of a vehicle, a time at which the vehicle has passed through the position, and a speed of the vehicle at the time; causing the computer to acquire destination information indicating a position of a destination of the vehicle; and causing the computer to determine an arrival time of the vehicle at the destination and a departure time of the vehicle from the destination, based on the travel record information and the destination information.

This configuration includes, as steps, characteristic processes in the above-described vehicle operation management system. Therefore, with this configuration, actions and effects similar to those of the above-described vehicle operation management system can be exhibited.
(8) A computer program according to another embodiment of the present disclosure causes a computer to function as: a travel record information acquisition unit configured to acquire travel record information indicating a position of a vehicle, a time at which the vehicle has passed through the position, and a speed of the vehicle at the time; a destination information acquisition unit configured to acquire destination information indicating a position of a destination of the vehicle; and a determination unit configured to determine an arrival time of the vehicle at the destination and a departure time of the vehicle from the destination, based on the travel record information and the destination information.

This configuration allows the computer to function as the above-described vehicle operation management system. Therefore, actions and effects similar to those of the above-described vehicle operation management system can be exhibited.

### Detailed Description of Embodiment of the Present Disclosure

Hereinafter, an embodiment of the present disclosure will be described with reference to the drawings. The embodiment described below merely shows, in any case, a specific example of the present disclosure. Numerical values, shapes, materials, components, arrangement positions and connection manners of components, steps, the order of steps, and the like shown in the embodiment below are merely examples, and are not intended to limit the present disclosure. Among the components in the embodiment below, a component not described in the independent claims is a component that can be optionally added. The drawings are given schematically and do not necessarily provide strict illustrations.

The same components are denoted by the same reference signs. The same applies to functions and names thereof, and therefore the description thereof is omitted as appropriate.

### [Overall Configuration of Vehicle Operation Management System]

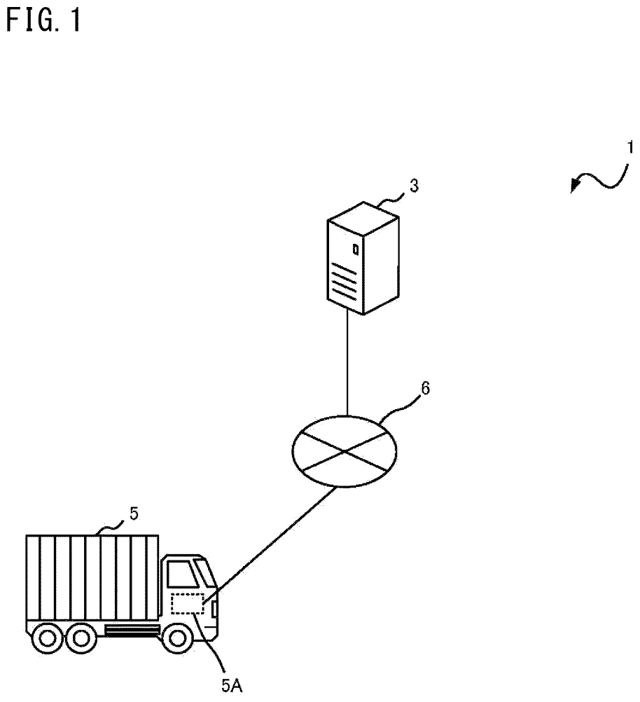

FIG. 1 is a diagram showing an overall configuration of a vehicle operation management system according to an embodiment of the present disclosure.

A vehicle operation management system 1 is a system in which operation management of a vehicle 5 is performed. Specifically, in the system, an arrival time of a cargo at a delivery destination which is a destination of the vehicle 5, and a departure time from the delivery destination are determined. The vehicle operation management system 1 includes an operation time analysis device 3, and an in-vehicle terminal 5A installed in the vehicle 5.

The vehicle 5 is a delivery vehicle that delivers a cargo, and includes the in-vehicle terminal 5A. The in-vehicle terminal 5A is a communication terminal installed in the vehicle 5 in advance. The in-vehicle terminal 5A is connected to a network 6 in a wireless manner. The in-vehicle terminal 5A generates travel record information including the position of the vehicle 5, a passing time of the vehicle 5 at the position, the speed of the vehicle 5 at the passing time, and sensor information detected by a sensor installed in the vehicle 5, and transmits the travel record information to the operation time analysis device 3 via the network 6.

The operation time analysis device 3 is connected to the network 6 in a wired or wireless manner. The operation time analysis device 3 receives the travel record information from the in-vehicle terminal 5A via the network 6. The operation time analysis device 3 analyzes an arrival time of the vehicle 5 at a delivery destination and a departure time of the vehicle 5 from the delivery destination, based on the received travel record information.

### [Configuration of In-Vehicle Terminal 5A]

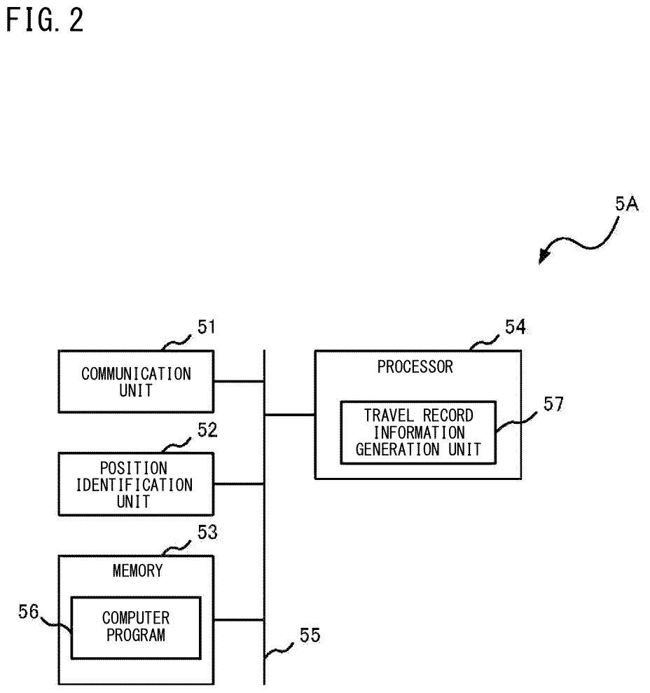

FIG. 2 is a block diagram showing a configuration of the in-vehicle terminal 5A.

The in-vehicle terminal 5A includes a communication unit 51, a position identification unit 52, a memory 53, a processor 54, and a bus 55.

The communication unit 51 performs communication with an external device in a wireless manner.

The position identification unit 52 identifies the position of the vehicle 5 using satellite navigation. For example, the position identification unit 52 includes a GPS (Global Positioning System) receiver. The position identification unit 52 identifies the position of the vehicle 5, based on radio waves received from a plurality of GPS satellites. The position of the vehicle 5 can be identified by, for example, latitude and longitude. The satellite navigation is performed using a global navigation satellite system (GNSS) such as a GPS, but the global navigation satellite system is not limited to the GPS.

The memory 53 is implemented as a volatile memory element such as an SRAM (Static RAM) or a DRAM (Dynamic RAM), a nonvolatile memory element such as a flash memory or an EEPROM (Electrically Erasable Programmable Read Only Memory), a magnetic storage device such as a hard disk drive, or the like. The memory 53 stores therein a computer program 56 to be executed by the processor 54. In addition, the memory 53 stores therein data used at the time of execution of the computer program 56, and data generated at the time of execution of the computer program 56.

The processor 54 is implemented as a CPU (Central Processing Unit) or the like, and includes a travel record information generation unit 57 as a functional processing unit implemented through execution of the computer program 56 stored in the memory 53.

The travel record information generation unit 57 acquires the position of the vehicle 5 from the position identification unit 52. In addition, the travel record information generation unit 57 acquires, from a clock of the vehicle 5, a time at which the position of the vehicle 5 has been identified by the position identification unit 52, and determines that the acquired time is a passing time of the vehicle 5. Further, the travel record information generation unit 57 acquires, from a speed indicator of the vehicle 5, the speed of the vehicle 5 at the passing time of the vehicle 5. In addition, the travel record information generation unit 57 acquires, from the sensor installed in the vehicle 5, the sensor information detected by the sensor at the passing time of the vehicle 5. The travel record information generation unit 57 generates the travel record information including a terminal ID for identifying the in-vehicle terminal 5A, the position of the vehicle 5, the passing time of the vehicle 5 at the position, the speed of the vehicle 5, and the sensor information. For example, it is assumed that the sensor is an acceleration sensor of the vehicle 5 and that the sensor information is an acceleration of the vehicle 5 measured by the acceleration sensor.

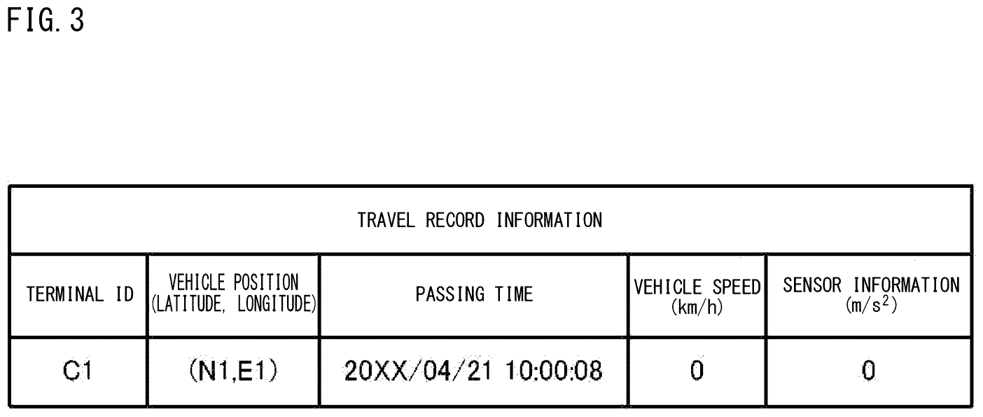

FIG. 3 shows an example of the travel record information generated by the travel record information generation unit 57.

The travel record information includes the terminal ID of the in-vehicle terminal 5A installed in the vehicle 5, the position of the vehicle 5, the passing time of the vehicle 5 at the position, the speed of the vehicle 5, and the sensor information.

For example, the terminal ID is “C1”, the position (latitude, longitude) of the vehicle 5 is (N1, E1), and the passing time at the position (N1, E1) is “10:00:08, April 21, 20XX”. In addition, the speed of the vehicle 5 at the passing time is “0 km/h” (the speed of the vehicle 5 at the time of passing through the position (N1, E1)), and the sensor information is “0 m/s²”.

The processor 54 periodically transmits the travel record information generated by the travel record information generation unit 57 to the operation time analysis device 3 through the communication unit 51.

The bus 55 mutually connects the communication unit 51, the position identification unit 52, the memory 53, and the processor 54.

### [Configuration of Operation Time Analysis Device 3]

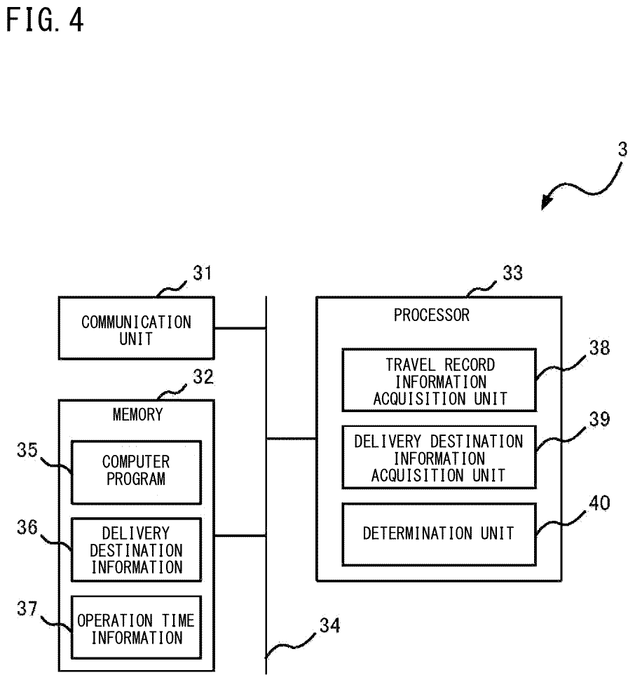

FIG. 4 is a block diagram showing a configuration of the operation time analysis device 3. The operation time analysis device 3 includes a communication unit 31, a memory 32, a processor 33, and a bus 34.

The communication unit 31 performs communication with an external device in a wireless or wired manner.

The memory 32 is implemented as a volatile memory element such as an SRAM or a DRAM, a nonvolatile memory element such as a flash memory or an EEPROM, a magnetic storage device such as a hard disk drive, or the like. The memory 32 stores therein a computer program 35 to be executed by the processor 33. In addition, the memory 32 stores therein data such as delivery destination information 36 used at the time of execution of the computer program 35, and data such as operation time information 37 generated at the time of execution of the computer program 35.

The processor 33 is implemented as a CPU or the like, and includes a travel record information acquisition unit 38, a delivery destination information acquisition unit 39, and a determination unit 40, as functional processing units implemented through execution of the computer program 35 stored in the memory 32.

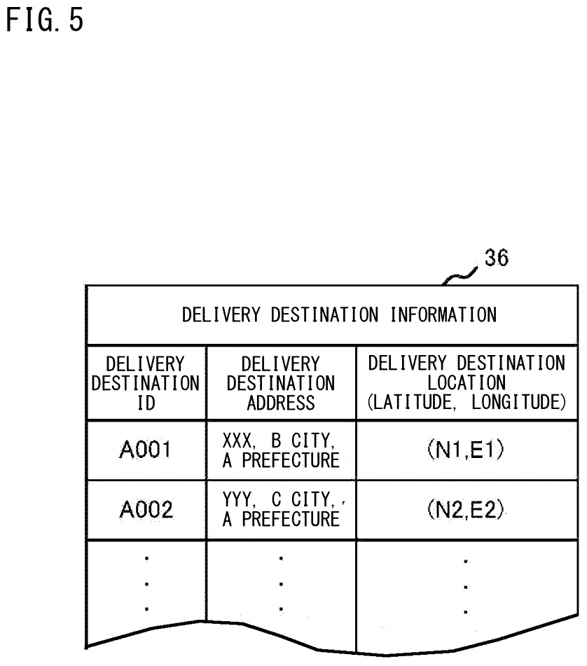

FIG. 5 shows an example of the delivery destination information 36.

The delivery destination information 36 includes a delivery destination ID for identifying a delivery destination, a delivery destination address, and a delivery destination location. The delivery destination location is expressed as a pair of latitude and longitude.

For example, a delivery destination address identified by a delivery destination ID of “A001” is “XXX, B City, A Prefecture”, and a delivery destination location is (N1, E1). A delivery destination address identified by a delivery destination ID of “A002” is “YYY, C City, A Prefecture”, and a delivery destination location is (N2, E2).

With reference to FIG. 4, again, the travel record information acquisition unit 38 periodically acquires the travel record information from the in-vehicle terminal 5A through the communication unit 31. The example of the travel record information acquired by the travel record information acquisition unit 38 is as shown in FIG. 3.

The delivery destination information acquisition unit 39 reads the delivery destination information 36 stored in the memory 32, to acquire the delivery destination information 36.

The determination unit 40 determines an arrival time of the vehicle 5 at a delivery destination and a departure time of the vehicle 5 from the delivery destination, based on the travel record information acquired by the travel record information acquisition unit 38 and the delivery destination information 36 acquired by the delivery destination information acquisition unit 39. A method for determining the arrival time at and the departure time from the delivery destination will be described below. The determination unit 40 stores the arrival time at and the departure time from the delivery destination which have been determined, as the operation time information 37, into a memory 32.

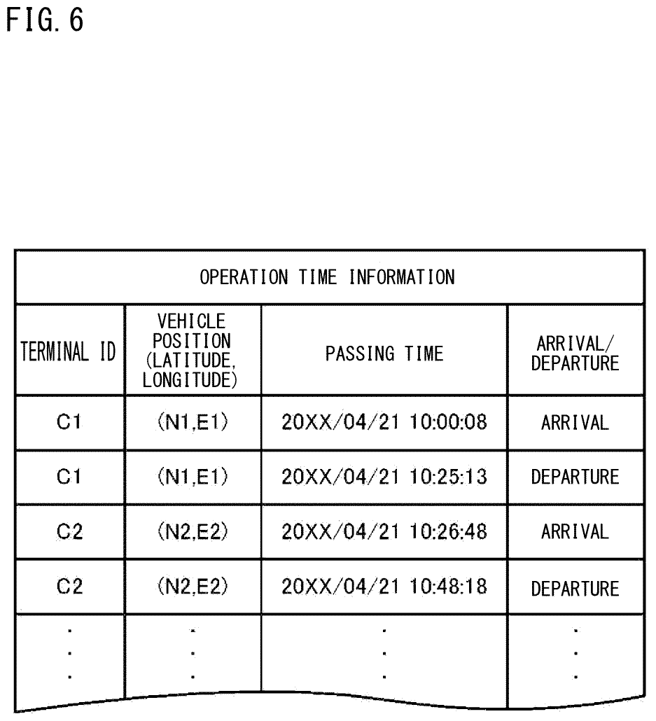

FIG. 6 shows an example of the operation time information 37.

The operation time information 37 includes the terminal ID of the in-vehicle terminal 5A installed in the vehicle 5, the position of the vehicle 5, a passing time of the vehicle 5 at the position, and information indicating whether the vehicle 5 has arrived or has departed.

For example, the operation time information 37 indicates that a vehicle 5 with a terminal ID of “C1” has passed through a vehicle position (N1, E1) at “20XX/04/21 10:00:08”, and that the vehicle 5 “has arrived” at the position at the time. The operation time information 37 indicates that the vehicle 5 with the terminal ID of “C1” has passed through the vehicle position (N1, E1) at “20XX/04/21 10:25:13”, and that the vehicle 5 “has departed” from the position at the time.

The bus 34 mutually connects the communication unit 31, the memory 32, and the processor 33.

### [Processing Procedure of Operation Time Analysis Device 3]

Next, the method by which the operation time analysis device 3 determines the arrival time at the delivery destination and the departure time from the delivery destination will be described.

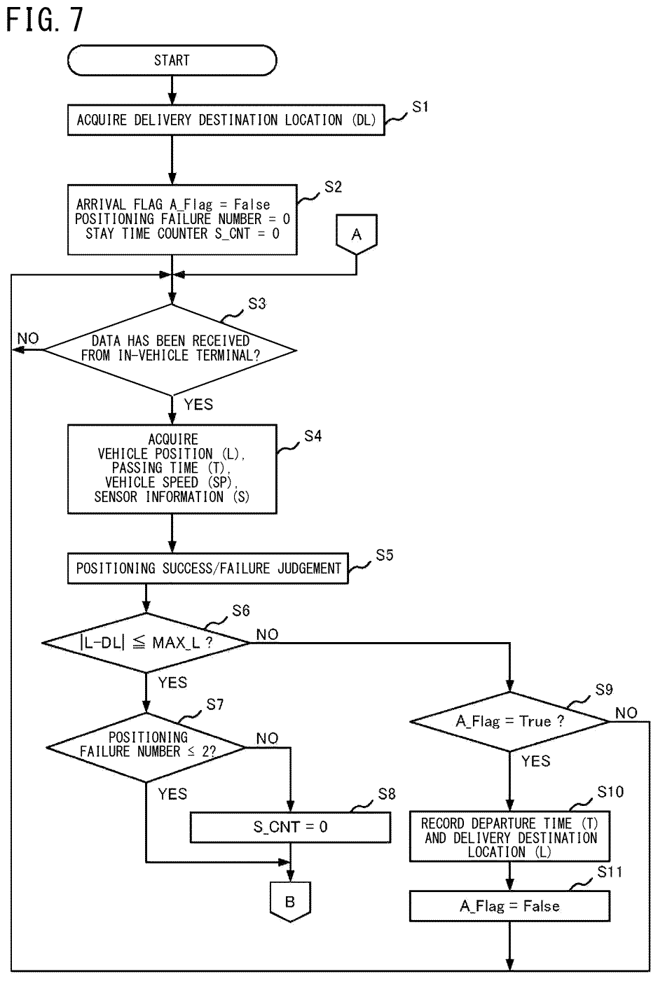

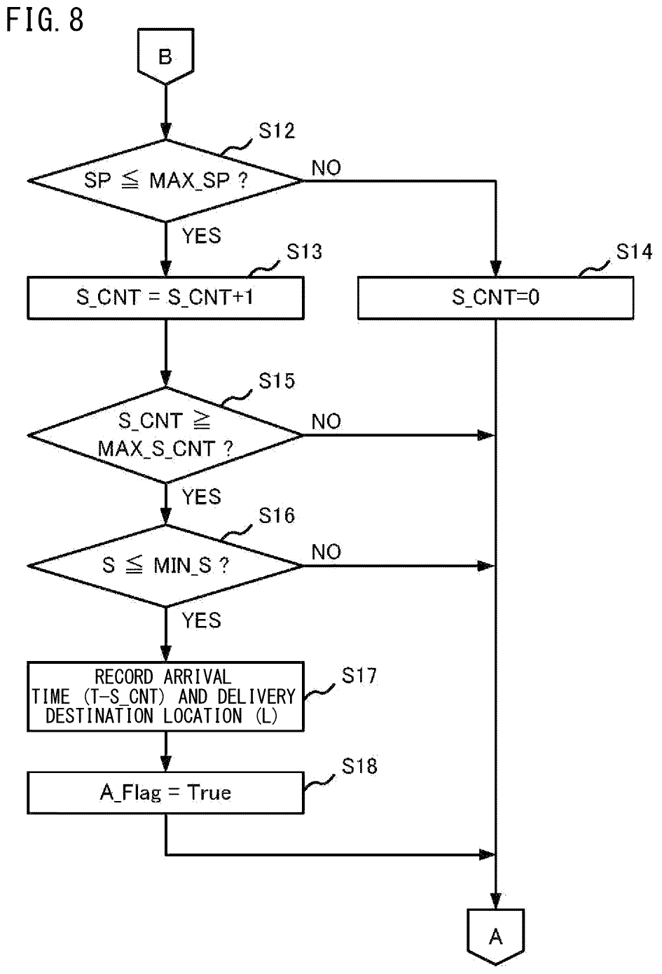

FIG. 7 and FIG. 8 are flowcharts each showing a processing procedure of the operation time analysis device 3. Each process shown in FIG. 7 and FIG. 8 is performed in the cycle of one second, for example.

With reference to FIG. 7, the delivery destination information acquisition unit 39 reads the delivery destination information 36 from the memory 32, to acquire one delivery destination location (DL) (step S1). The example of the delivery destination information 36 is as shown in FIG. 5. For example, the delivery destination information acquisition unit 39 acquires, as the delivery destination location (DL), a delivery destination location (N1, E1) corresponding to a delivery destination ID of “A001”.

The determination unit 40 assigns False into an arrival flag A_Flag, resets a positioning failure number to 0, and resets a stay time counter S_CNT to 0 (step S2). Here, A_Flag is data representing whether or not the vehicle 5 has arrived at a delivery destination.

A_Flag of True indicates that the vehicle 5 has arrived at a delivery destination (here, the delivery destination corresponding to the delivery destination ID of “A001”), and A_Flag of False indicates that the vehicle 5 has not arrived at the delivery destination.

In a positioning success/failure judgement process (step S5) described below, the positioning failure number represents the number of times that the position identification unit 52 of the in-vehicle terminal 5A is judged to have failed in identifying the position of (positioning) the vehicle.

S_CNT represents a stay time of the vehicle 5 at the delivery destination.

The communication unit 31 waits until receiving data from the in-vehicle terminal 5A (step S3).

If the communication unit 31 receives the data (YES in step S3), the travel record information acquisition unit 38 acquires a position (L) of the vehicle 5, a passing time (T) of the vehicle 5 at the position (L), a speed (SP) of the vehicle 5 at the position (L), and sensor information (S), from the travel record information included in the received data (step S4). The example of the travel record information is as shown in FIG. 3.

The determination unit 40 judges whether or not the position identification unit 52 of the in-vehicle terminal 5A has succeeded in positioning the vehicle 5, based on the position (L) of the vehicle 5 acquired in step S4. If the determination unit 40 has judged that the position identification unit 52 has failed in positioning the vehicle, the determination unit 40 increments the positioning failure number by 1 (step S5). For example, if the position (L) of the vehicle 5 is an indefinite value or if the position (L) of the vehicle 5 is an apparently erroneous value (e.g., a value equal to or more than a predetermined threshold), the determination unit 40 judges that positioning of the vehicle 5 has failed. In cases other than the above, the determination unit 40 judges that positioning of the vehicle 5 has succeeded. Failure in positioning is likely to occur under poor radio wave conditions, for example, in a case where the vehicle 5 travels in a tunnel or in a case where the vehicle 5 travels in the mountains.

The determination unit 40 judges whether or not a distance |L−DL| between the position (L) of the vehicle 5 and the delivery destination location (DL) is equal to or less than a threshold MAL_L (step S6).

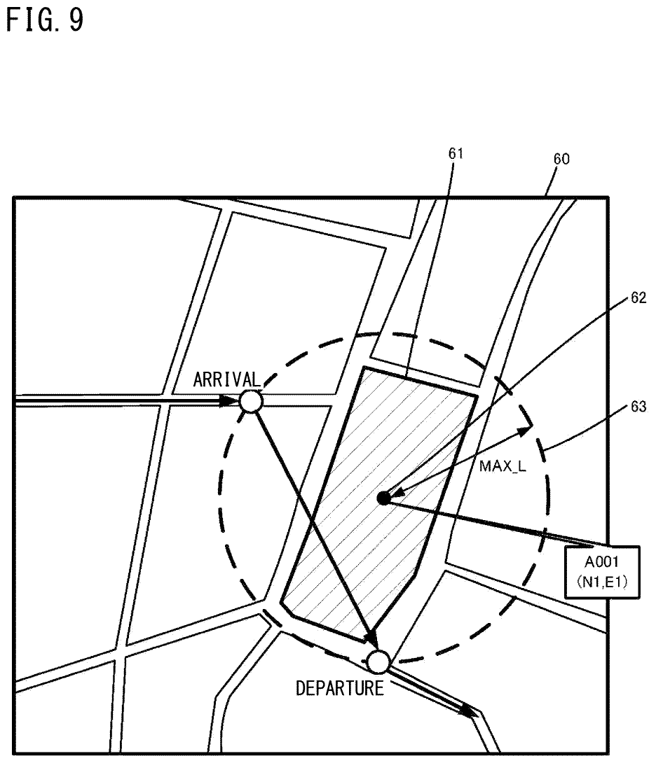

FIG. 9 shows a map of the area around the delivery destination. In a map 60, the region of a delivery destination 61 is shown by hatching, and it is assumed that a center 62 of the delivery destination 61 is a delivery destination location. However, the delivery destination location is not limited to the center 62 of the delivery destination 61, and any position in the delivery destination 61 may be the delivery destination location. A circle having a radius MAX_L and having the delivery destination location (here, the center 62) as the center of the circle, is a geo-fence 63. The geo-fence 63 is a boundary to be used to judge whether or not the vehicle 5 has arrived at the delivery destination 61 and whether or not the vehicle 5 has departed from the delivery destination 61. If the judgement result of step S6 is true (|L−DL|≤MAX_L), it means that the vehicle 5 is located inside the geo-fence 63.

If |L−DL|≤MAX_L (YES in step S6), the determination unit 40 judges whether or not the positioning failure number is equal to or less than a threshold of 2 (step S7). However, the threshold is not limited to 2. If the positioning failure number exceeds 2 (NO in step S7), the determination unit 40 resets S_CNT to 0 (step S8).

If the positioning failure number is equal to or less than 2 (YES in step S7), or after a reset process has been performed (step S8), the determination unit 40 judges whether or not the speed (SP) of the vehicle 5 is equal to or less than a threshold MAX_SP (step S12).

Here, the threshold MAX_SP is used to judge whether or not the vehicle 5 is stopped, and is 0 or a value sufficiently close to 0. A condition obtained by combining step S6 and step S12 corresponds to a stay condition indicating that the vehicle 5 stays at the delivery destination location (DL).

If SP≤MAX_SP (YES in step S12), the vehicle 5 is considered stopped inside the geo-fence 63. Thus, the determination unit 40 increments S_CNT by only 1 (step S13).

The determination unit 40 judges whether or not S_CNT is equal to or more than a threshold MAX_S_CNT (step S15). The threshold MAX_S_CNT is a threshold for judging that the vehicle 5 is stopped for a sufficient time.

If S_CNT≥MAX_S_CNT (YES in step S15), the determination unit 40 judges whether or not the sensor information (S) is equal to or less than a threshold MIN_S (step S16). For example, it is assumed that the sensor is an acceleration sensor of the vehicle 5 and that the sensor information is an acceleration of the vehicle 5 measured by the acceleration sensor. In this case, the determination unit 40 judges whether or not the acceleration of the vehicle 5 is equal to or less than the threshold MIN_S. The threshold MIN_S is a threshold for judging that the vehicle 5 is stopped, and if the judgement result of step S16 is true (S≤MIN_S), it can be judged that the vehicle 5 is surely stopped inside the geo-fence 63.

If S≤MIN_S (YES in step S16), the determination unit 40 writes a time obtained by subtracting a value of the stay time counter S_CNT from the passing time (T) of the vehicle 5 at the position (L), as a time at which the vehicle 5 has arrived at the delivery destination 61, into the operation time information 37. In addition, the determination unit 40 writes the position (L) of the vehicle 5, as the position of the delivery destination 61, into the operation time information 37 (step S17). The example of the operation time information 37 is as shown in FIG. 6.

Then, the determination unit 40 sets the arrival flag A_Flag to True (step S18), and returns the control to step S3.

If SP>MAX_SP (NO in step S12), it is judged that the vehicle 5 travels inside the geo-fence 63, and thus the determination unit 40 resets S_CNT to 0 (step S14) and returns the control to step S3.

If S_CNT<MAX_S_CNT (NO in step S15), it is judged that the vehicle 5 has not been stopped long enough to judge that the vehicle 5 is stopped inside the geo-fence 63, and thus the determination unit 40 returns the control to step S3.

If S>MIN_S (NO in step S16), it cannot be judged that the vehicle 5 is surely stopped inside the geo-fence 63, and thus the determination unit 40 returns the control to step S3.

If |L−DL|>MAX_L (NO in step S6), the determination unit 40 judges whether or not a value of A_Flag is True (step S9).

If the value of A_Flag is True (YES in step S9), it is supposed that the vehicle 5 has moved outside the geo-fence 63 after the vehicle 5 was judged to have arrived at the delivery destination. Thus, the determination unit 40 writes, into the operation time information 37, the passing time (T) of the vehicle 5 at the position (L) as a time at which the vehicle 5 has departed from the delivery destination 61. In addition, the determination unit 40 writes the position (L) of the vehicle 5, as the position of the delivery destination 61, into the operation time information 37 (step S10).

Then, the determination unit 40 sets the arrival flag A_Flag to False (step S11), and returns the control to step S3.

If the value of A_Flag is False (NO in step S9), the determination unit 40 returns the control to step S3.

The process of determining the arrival time at and the departure time from the delivery destination as shown in FIG. 7 and FIG. 8 is also performed with respect to the other delivery destinations (e.g., the delivery destination corresponding to the delivery destination ID of “A002”) in the same manner as that with respect to the delivery destination corresponding to the delivery destination ID of “A001”. In other words, the determination unit 40 performs the process of determining the arrival time at and the departure time from delivery destination as shown in FIG. 7 and FIG. 8 by the number of the delivery destinations in the delivery destination information 36, in parallel.

As described above, according to the embodiment of the present disclosure, based on a positional relationship between the vehicle 5 and the delivery destination, it can be judged that the vehicle 5 is present at the delivery destination and that the vehicle 5 has departed from the delivery destination. In addition, if the speed of the vehicle 5 is further considered, it can be judged whether or not the vehicle 5 has arrived at the delivery destination. Thus, based on the passing time of the vehicle 5 at the position, the arrival time of the vehicle 5 at and the departure time of the vehicle 5 from the delivery destination can be accurately identified.

In addition, the vehicle 5 is stopped after the vehicle 5 has arrived at the delivery destination, and thus the speed (SP) of the vehicle 5 becomes equal to or less than the threshold MAX_SP after the arrival at the delivery destination. Thus, judging whether or not the speed (SP) is equal to or less than the threshold MAX_SP allows the arrival time of the vehicle 5 at the delivery destination to be accurately determined.

In addition, if a state in which the speed (SP) is equal to or less than the threshold MAX_SP has been continuously satisfied for MAX_S_CNT or more, it indicates that the vehicle 5 neither is temporarily stopped at the delivery destination nor has passed through the delivery destination, but that the vehicle 5 has surely arrived at the delivery destination. Thus, a time at which the condition SP≤MAX_SP has started being satisfied is set as an arrival time at the delivery destination, whereby the arrival time of the vehicle 5 at the delivery destination can be accurately determined.

In addition, it is found that the vehicle 5 is stopped, based on the acceleration of the vehicle 5. Thus, the arrival time of the vehicle 5 at the delivery destination can be accurately determined by using the sensor information obtained by the acceleration sensor.

In addition, the positional relationship between the vehicle 5 and the delivery destination after the vehicle 5 has arrived at the delivery destination is used, whereby the departure time of the vehicle 5 from the destination can be accurately determined.

In addition, the reliability of the travel record information can be judged based on the positioning failure number. Thus, if the positioning failure number exceeds the threshold of 2, S_CNT is set to 0, whereby the arrival time at the delivery destination can be determined using the travel record information with high reliability

### [Modification]

In the above-described embodiment, the sensor information to be acquired by the operation time analysis device 3 is the acceleration of the vehicle 5 measured by the acceleration sensor. However, the sensor information is not limited to the acceleration of the vehicle 5.

For example, the sensor information may be the state of a handbrake of the vehicle 5, the open or closed state of a door of the vehicle 5, engine revolutions per minute of the vehicle 5, an operation state of an engine of the vehicle 5, or the information acquired by the vehicle 5 from a beacon installed at the delivery destination.

The state of the handbrake can be judged by a sensor provided to the handbrake. For example, the sensor information (S) indicates 0 for a state in which the handbrake is applied and 1 for a state in which the handbrake is not applied. In this case, the threshold MIN_S for judging that the vehicle 5 is stopped as shown in step S16 in FIG. 8 may be set to 0, for example.

The open or closed state of the door of the vehicle 5 can be judged from an output of a proximity sensor that is provided to the door and detects the open or closed state of the door. For example, the sensor information (S) indicates 0 for a state in which the door is open and 1 for a state in which the door is closed. In this case, the threshold MIN_S for judging that the vehicle 5 is stopped as shown in step S16 in FIG. 8 may be set to 0, for example.

The engine revolutions per minute of the vehicle 5 can be detected by, for example, a crank angle sensor, a cam position sensor, a gear tooth sensor, or the like.

The operation state of the engine of the vehicle 5 can be detected by, for example, the crank angle sensor, the cam position sensor, the gear tooth sensor, or the like. For example, the sensor information (S) indicates 0 for a state in which the engine is stopped and 1 for a state in which the engine is operated. In this case, the threshold MIN_S for judging that the vehicle 5 is stopped as shown in step S16 in FIG. 8 may be set to 0, for example.

The sensor information (S) may be the information acquired by the vehicle 5 from the beacon installed at the delivery destination (e.g., the beacon installed at an entrance of the delivery destination). In this case, the sensor is a beacon receiver installed in the vehicle 5, and the sensor information (S) indicates 0 in a case where the information has been received from the beacon installed at the delivery destination, and indicates 1 in a case where no information has been received. In this case, the threshold MIN_S for judging that the vehicle 5 is stopped as shown in step S16 in FIG. 8 may be set to 0, for example.

The vehicle 5 is also confirmed to be stopped, based on the above sensor information (S). Thus, the arrival time of the vehicle 5 at the delivery destination can be accurately determined by using the sensor information (S).

### Additional Note

A part or the entirety of components forming each device described above may be implemented as a single or a plurality of semiconductor devices such as a system LSI.

The above-described computer program may be distributed in a state of being recorded in a computer-readable non-transitory storage medium such as an HDD (Hard Disk Drive), a CD-ROM, or a semiconductor memory. In addition, the computer program may be distributed by being transmitted through an electric communication line, a wireless/wired communication line, a network represented by the Internet, data broadcasting, or the like.

The above-described devices may be implemented by a plurality of computers or a plurality of processors.

A part or the entirety of the functions of each device described above may be provided by cloud computing. That is, a part or the entirety of the functions of each device may be achieved by a cloud server.

Further, at least some parts of the above embodiment and the above modification may be combined as desired.

The disclosed embodiment is merely illustrative in all aspects and should be considered not restrictive. The scope of the present disclosure is defined by the scope of the claims rather than the meaning described above, and is intended to include meaning equivalent to the scope of the claims and all modifications within the scope.

### REFERENCE SIGNS LIST

1 vehicle operation management system
3 operation time analysis device
5 vehicle
5A in-vehicle terminal
6 network
31 communication unit
32 memory
33 processor
34 bus
35 computer program
36 delivery destination information (destination information)
37 operation time information
38 travel record information acquisition unit
39 delivery destination information acquisition unit
40 determination unit
51 communication unit
52 position identification unit
53 memory
54 processor
55 bus
56 computer program
57 travel record information generation unit
60 map
61 delivery destination
62 center
63 geo-fence

1. A vehicle operation management system comprising:
a travel record information acquisition unit configured to acquire travel record information indicating a position of a vehicle, a time at which the vehicle has passed through the position, and a speed of the vehicle at the time;
a destination information acquisition unit configured to acquire destination information indicating a position of a destination of the vehicle; and
a determination unit configured to determine an arrival time of the vehicle at the destination and a departure time of the vehicle from the destination, based on the travel record information and the destination information.

2. The vehicle operation management system according to claim 1, wherein
the determination unit determines the arrival time of the vehicle at the destination, based on a result of a judgement on a stay condition indicating that a distance between the vehicle and the destination is equal to or less than a distance threshold and that the speed of the vehicle is equal to or less than a speed threshold.

3. The vehicle operation management system according to claim 2, wherein
the determination unit determines that a time at which the stay condition has started being satisfied is the arrival time of the vehicle at the destination, in a case where the stay condition has been continuously satisfied for a time threshold or more.

4. The vehicle operation management system according to claim 1, wherein
the travel record information includes sensor information indicating at least one of a state of a handbrake of the vehicle, an open or closed state of a door of the vehicle, an acceleration of the vehicle, engine revolutions per minute of the vehicle, an operation state of an engine of the vehicle, and information acquired by the vehicle from a beacon installed at the destination.

5. The vehicle operation management system according to claim 2, wherein
the determination unit determines, as the departure time of the vehicle from the destination, a time at which a distance between the vehicle and the destination has exceeded the distance threshold after the vehicle has arrived at the destination.

6. The vehicle operation management system according to claim 3, wherein
the determination unit resets a continuous duration period of the stay condition to 0, in a case where the number of failures in positioning of the vehicle acquired by the travel record information acquisition unit has exceeded a predetermined number.

7. A vehicle operation management method comprising:
causing a computer to acquire travel record information indicating a position of a vehicle, a time at which the vehicle has passed through the position, and a speed of the vehicle at the time;
causing the computer to acquire destination information indicating a position of a destination of the vehicle; and
causing the computer to determine an arrival time of the vehicle at the destination and a departure time of the vehicle from the destination, based on the travel record information and the destination information.

8. A computer program for causing a computer to function as:
a travel record information acquisition unit configured to acquire travel record information indicating a position of a vehicle, a time at which the vehicle has passed through the position, and a speed of the vehicle at the time;
a destination information acquisition unit configured to acquire destination information indicating a position of a destination of the vehicle; and
a determination unit configured to determine an arrival time of the vehicle at the destination and a departure time of the vehicle from the destination, based on the travel record information and the destination information.
